(19) United States
(12) Patent Application Publication
(10) Pub. No.: US 2025/0074349 A1
(43) Pub. Date: Mar. 6, 2025

(54) AIRBAG DEVICE

(71) Applicant: TOYODA GOSEI CO., LTD., Kiyosu-shi (JP)

(72) Inventors: Takuya HIRAIWA, Kiyosu-shi (JP); Nobuya NAKAKURA, Kiyosu-shi (JP); Daisuke KITAMURA, Kiyosu-shi (JP); Shinichi ISHIDA, Kiyosu-shi (JP); Kazuma SUZUKI, Kiyosu-shi (JP)

(21) Appl. No.: 18/812,610

(22) Filed: Aug. 22, 2024

(30) Foreign Application Priority Data
Sep. 5, 2023 (JP) 2023-143905

(51) Int. Cl. B60R 21/217; B60R 21/00; B60R 21/205

(52) U.S. Cl. CPC B60R 21/217; B60R 21/205; B60R 2021/0004

(57) ABSTRACT

A bag holder includes an insertion hole allowing a main body of an inflator to be inserted. A retainer includes a pressing portion that presses a peripheral edge of an inflow opening of an airbag, and an internal thread is provided on an inner peripheral surface side of the pressing portion. The inflator includes an external thread screwable to the internal thread on an outer peripheral surface side, in the main body. The retainer causes, at the time of screwing the internal thread and the external thread to each other, the pressing portion and the flange portion to sandwich a portion of a peripheral edge of the insertion hole in the bag holder, thereby causing the bag holder to hold the airbag and the inflator. The retainer includes a projection extending from the pressing portion and capable of penetrating through the airbag and the bag holder.

### CROSS REFERENCE TO RERATED APPLICATION

The present application claims priority from Japanese Patent Application No. 2023-143905 of Hiraiwa et al., filed on Sep. 5, 2023, the entire disclosures of which are incorporated herein by reference.

### BACKGROUND

### 1. Technical Field

The present disclosure relates to an airbag device having a configuration in which an airbag and an inflator that supplies inflation gas to the airbag are held by a bag holder by using a retainer.

### 2. Description of Related Art

Conventionally, as an airbag device, there is an airbag device disclosed in JP H5-270348 A. In this conventional airbag device, an internal thread and an external thread that can be screwed to each other are respectively provided in an inner peripheral surface side of a retainer and an outer peripheral surface side of a main body of an inflator inserted in the inner peripheral side of the retainer, and the inflator is attached to the retainer by screw coupling between the internal thread and the external thread.

In the conventional airbag device, the retainer has a structure in which a portion to which the inflator is attached and a member equivalent to a bag holder that holds the airbag are combined. Furthermore, when the internal thread and the external thread are screwed to each other simultaneously at the time of inserting the main body of the inflator into the retainer, the inflator can be connected to the retainer. As a result, as described in the conventional art of JP H5-270348 A, the work to connect the inflator to the retainer is easy as compared with the case of using a pressing ring (retainer) from which four bolts are projected. However, although, in the conventional airbag device, the connection structure between the inflator and the retainer (bag holder) is disclosed, the following structures are not disclosed at all: an attachment structure in which the airbag is attached to the retainer (bag holder); and a locking structure in which the retainer is locked to the peripheral edge of an inflow opening of the airbag.

### SUMMARY

An airbag device of the present disclosure includes:
an airbag;
an inflator, the inflator including
   a main body having a substantially columnar shape, and
   a flange portion projecting from the main body, the inflator supplying inflation gas to the airbag;
a bag holder having an insertion hole that allows the main body to be inserted through the bag holder, the bag holder holding the airbag and the inflator; and
a retainer with which the airbag and the inflator are held by the bag holder,
wherein
the retainer has a substantially annular shape that allows the main body to be inserted through the retainer,
the retainer has a pressing portion that is configured to press, from an inner peripheral side, a peripheral edge of an inflow opening that is provided in the airbag so as to allow the main body to be inserted,
the retainer includes an internal thread on an inner peripheral surface side of the pressing portion, and
the inflator includes an external thread on an outer peripheral surface side near the flange portion of the main body, the external thread configured to be screwed to the internal thread, and
wherein
the retainer is configured to cause the bag holder to hold the airbag and the inflator by causing, when the external thread and the internal thread are screwed to each other, the pressing portion and the flange portion to sandwich a portion of a peripheral edge of the insertion hole in the bag holder, and
the retainer includes a projection that projects from the pressing portion so as to penetrate through the airbag and the bag holder.

### BRIEF DESCRIPTION OF THE DRAWINGS

FIG. 1 is a schematic vertical sectional view of an airbag device for a passenger seat according to an embodiment of the present disclosure mounted on a vehicle;

FIG. 2 is a vertical sectional view of the airbag device for a passenger seat according to the embodiment taken along the front-rear direction;

FIG. 3 is a vertical sectional view of the airbag device for a passenger seat according to the embodiment taken along the left-right direction;

FIG. 4 is a partially enlarged cross-sectional view illustrating the vicinity of an inflator and a retainer in FIG. 3;

FIG. 5 is a schematic exploded perspective view illustrating the airbag, a case, the retainer, and the inflator in the airbag device for a passenger seat according to the embodiment;

FIG. 6 is a plan view of the retainer used in the airbag device for a passenger seat according to the embodiment;

FIG. 7 is a front view of the retainer in FIG. 6;

FIG. 8 is a left side view of the retainer in FIG. 6; and

FIG. 9 is a vertical sectional view of the retainer in FIG. 6.

### DETAILED DESCRIPTION

Preferred embodiments of the present invention are described below with reference to the accompanying drawings. However, the invention is not limited to the embodiments disclosed herein. All modifications within the appended claims and equivalents relative thereto are intended to be encompassed in the scope of the claims.

Hereinafter, an embodiment of the present disclosure will be described with reference to the drawings. In the embodiment, an airbag device M for a passenger seat (hereinafter, abbreviated as “airbag device”) will be described as an example. In the embodiment, the front-rear, up-down, and left-right directions coincide with the front-rear, up-down, and left-right directions of a vehicle when the airbag device M is mounted on the vehicle, unless otherwise specified.

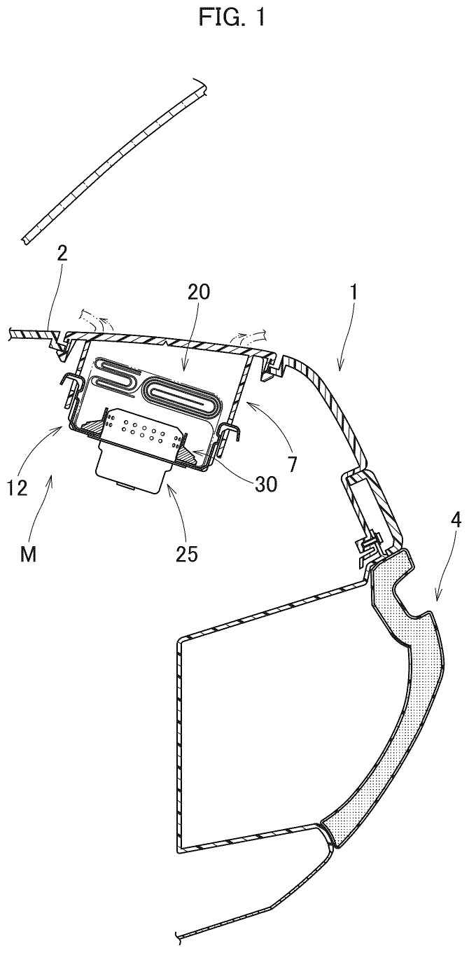

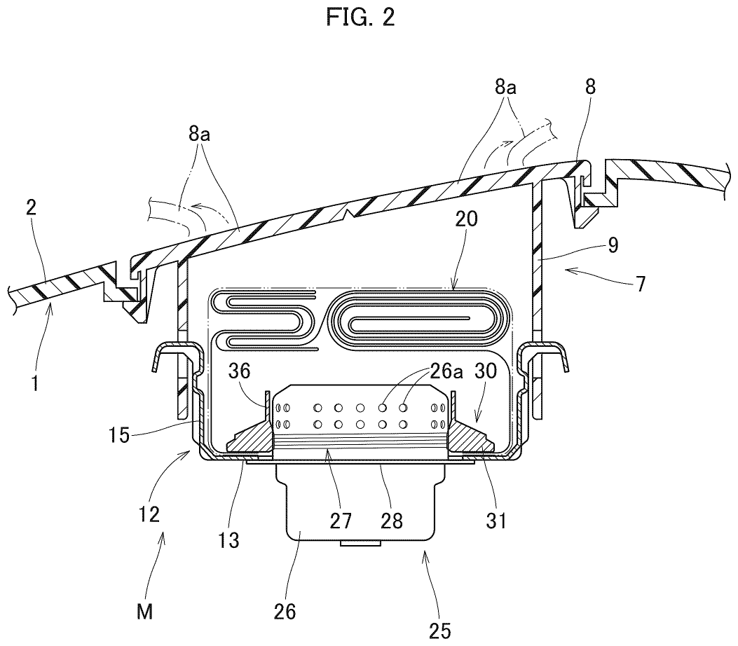

As illustrated in FIG. 1, the airbag device M is disposed inside an upper surface 2 of an instrument panel 1, in front of a passenger seat (not illustrated) in a vehicle. As illustrated in FIGS. 2, 3, and 5, the airbag device M includes: an airbag 20 that is folded; an inflator 25 that supplies inflation gas to the airbag 20; a case 12 serving as a bag holder that holds the airbag 20 and the inflator 25; a retainer 30 for attaching the airbag 20 and the inflator 25 to the case 12; and an airbag cover 7 covering the folded airbag 20.

In the case of the embodiment, the airbag cover 7 is formed separately from the instrument panel 1 made of synthetic resin, and is disposed at a portion of an opening of the instrument panel 1 (see FIGS. 1 to 3). The airbag cover 7 is made of synthetic resin such as a polyolefin-based thermoplastic elastomer. The airbag cover 7 includes: a ceiling wall portion 8 that closes an area of an opening on the upper end side of the case 12; and a peripheral wall portion 9 that extends downward from a peripheral edge of the ceiling wall portion 8 and is attached to a side wall portion 15 of the case 12. The ceiling wall portion 8 is provided with two door portions 8a and 8a that can be opened forward and backward when the airbag 20 is unfolded and inflated.

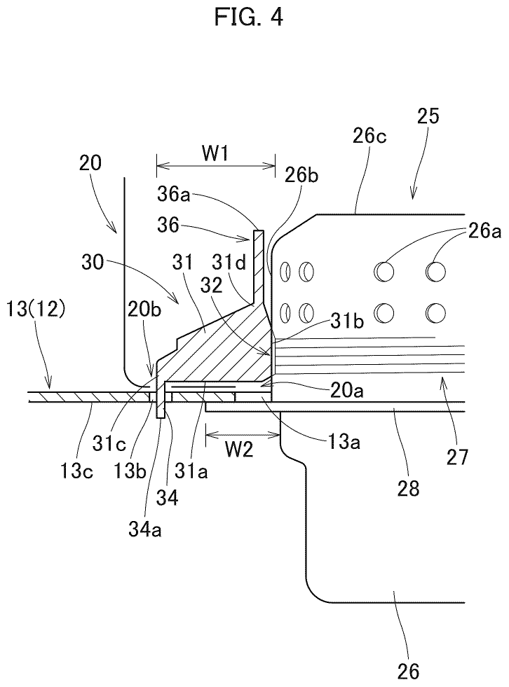

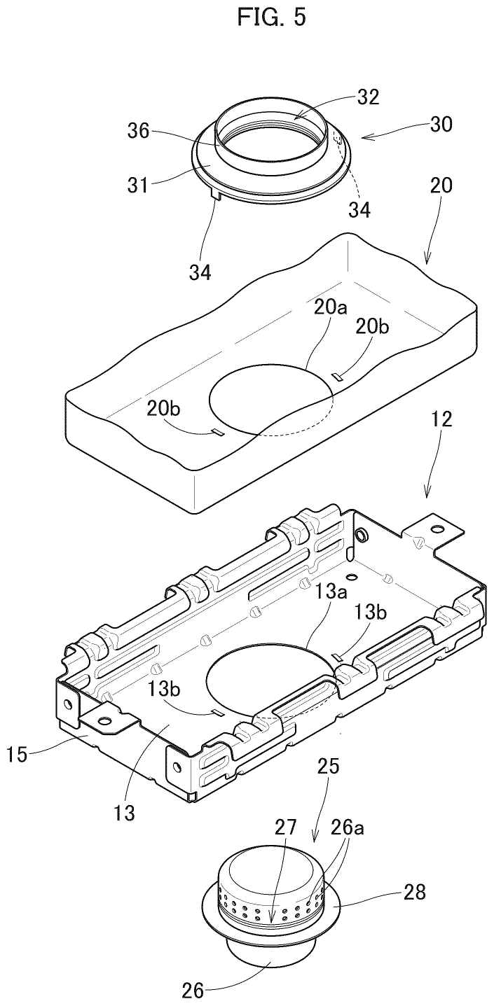

The case 12 serving as the bag holder houses and holds the folded airbag 20 and the inflator 25. The case 12 is made of a metal plate and has a substantially box shape that is opened on the upper end side. In detail, as illustrated in FIG. 5, the case 12 has a substantially rectangular parallelepiped shape that is wider in the left-right direction. The case 12 includes: a bottom wall portion 13; and the side wall portion 15 having a substantially tubular shape extending upward from an outer peripheral edge of the bottom wall portion 13, and is attached to the airbag cover 7 at the portion of the side wall portion 15. The bottom wall portion 13 has a substantially rectangular shape wider in the left-right direction. At the center of the bottom wall portion 13, an insertion hole 13a is formed to be opened in a substantially circular shape so as to allow a main body 26 (to be described later) of the inflator 25 to be inserted therethrough (see FIG. 5). In the bottom wall portion 13, locking holes 13b having a slit shape are formed to cause projected pieces 34 (projections), to be described later, of the retainer 30 to project through the locking holes 13b and to be locked at the peripheral edge. Specifically, the locking holes 13b are formed at positions on both the left and right sides of the insertion hole 13a, in detail, at two places substantially point-symmetric with respect to the insertion hole 13a (see FIGS. 4 and 5).

The airbag 20 is configured in a flexible bag shape into which inflation gas is flown, and is folded and stored in the case 12. Although not illustrated in detail, the airbag 20 is configured so as to be able to protect an occupant seated on a passenger seat when completely inflated. In the airbag 20, an inflow opening 20a through which inflation gas can flow is formed to have a substantially circular shape (see FIG. 5). An inner diameter dimension of the inflow opening 20a is set to such a dimension that the main body 26 of the inflator 25 can be inserted. In a peripheral edge of the inflow opening 20a of the airbag 20, through-holes 20b (see FIGS. 4 and 5) are formed in a slit shape to allow the projected pieces 34 (projections) of the retainer 30 to penetrate. As illustrated in FIG. 5, the through-holes 20b are formed at two places that correspond to the locking holes 13b formed in the bottom wall portion 13 of the case 12 and are substantially point-symmetric with respect to the inflow opening 20a.

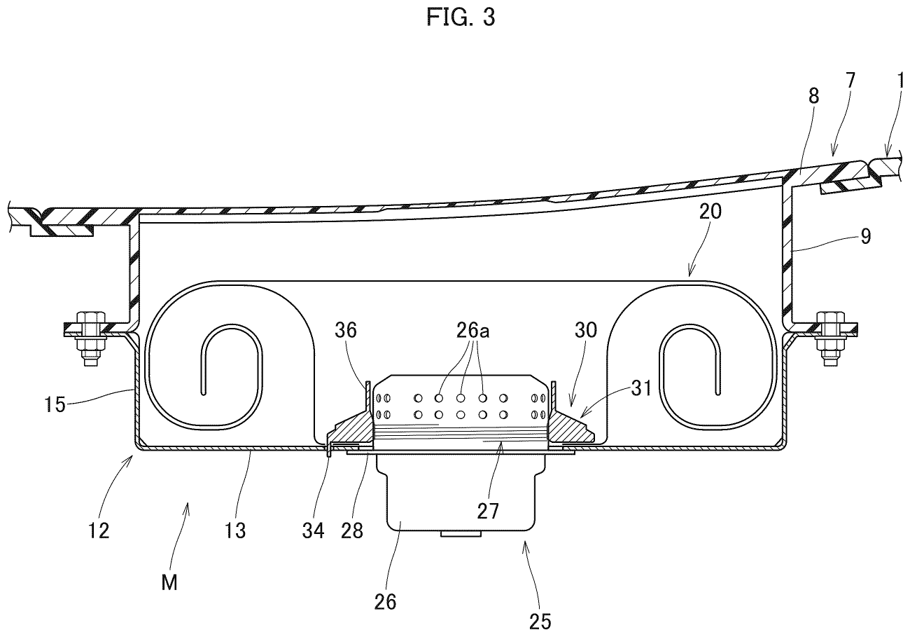

As illustrated in FIG. 5, the inflator 25 includes: the main body 26 having a substantially columnar shape; and a flange portion 28 formed to project from the main body 26. The main body 26 has an outer diameter dimension set to be smaller than an inner diameter dimension of the insertion hole 13a formed in the bottom wall portion 13 of the case 12, and is configured to be insertable into the insertion hole 13a (see FIGS. 2 and 3). The flange portion 28 has a substantially discoid outer shape. The outer diameter dimension of the flange portion 28 is set to be larger than the inner diameter dimension of the insertion hole 13a formed in the bottom wall portion 13. In the case of the embodiment, the flange portion 28 is provided at a substantially vertically central position of the main body 26. On the side of an outer peripheral surface, in the direction around the axis, in the upper side region in the main body 26, a large number of gas discharge ports 26a capable of discharging inflation gas are radially provided. On the main body 26, an external thread 27 is formed, over the entire circumference, on the outer peripheral surface 26b side and in the vicinity of the flange portion 28 (see FIGS. 2 to 5). Specifically, in the case of the embodiment, the external thread 27 is formed on the outer peripheral surface 26b side of the region that is below the region on which the gas discharge ports 26a are provided and in the upper vicinity of the flange portion 28. The external thread 27 is configured to be screwable to an internal thread 32 formed on an inner peripheral surface 31b side of a pressing portion 31, to be described later, of the retainer 30. In the case of the embodiment, the external thread 27 and the corresponding internal thread 32 are formed in about a lower ⅕ portion of a region of the main body 26, above the flange portion 28. In the case of the embodiment, a generally used anti-loosening agent is applied onto the outer peripheral side of the external thread 27 (between the external thread 27 and the internal thread 32).

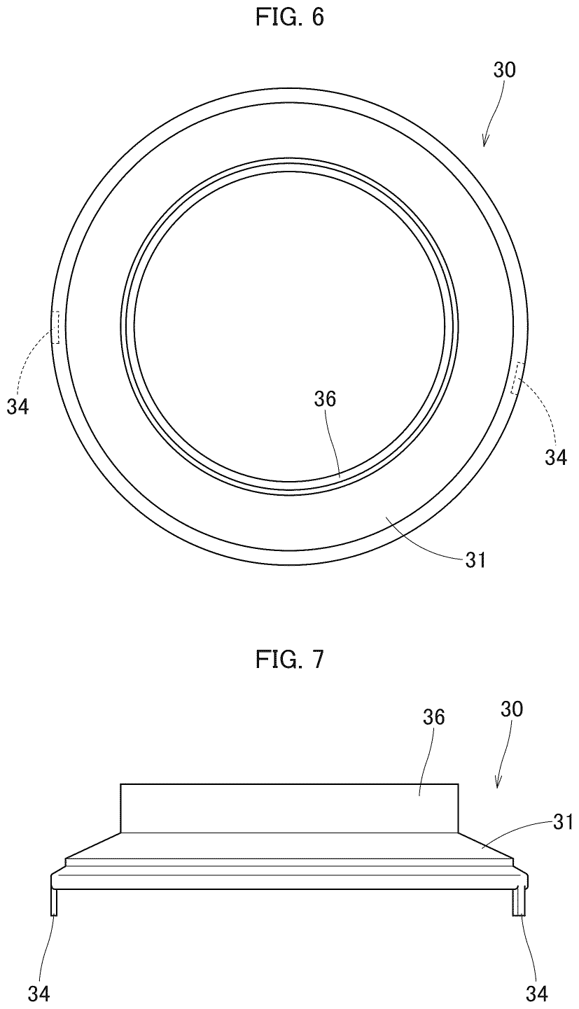

The retainer 30 is made of metal and has a substantially annular shape through which the main body 26 of the inflator 25 can be inserted. In the case of the embodiment, as illustrated in FIGS. 5 and 6, the retainer 30 has a substantially circular annular outer shape and is formed by forging. The retainer 30 includes: the pressing portion 31 capable of pressing the peripheral edge of the inflow opening 20a of the airbag 20 from the inner peripheral side of the airbag 20; the projected pieces 34 serving as the projections and extending downward from the pressing portion 31; and a side wall portion 36 extending upward from the pressing portion 31. In the case of the embodiment, the pressing portion 31 is configured such that a lower surface side, which is on the bottom wall portion 13 side of the case 12, of the pressing portion 31 lies, as a pressing surface 31a pressing the peripheral edge of the inflow opening 20a, along the bottom wall portion 13 of the case 12 (see FIGS. 4 and 9). As illustrate in FIG. 9, the pressing portion 31 is configured such that an inner peripheral surface 31b, which is on the main body 26 side of the inflator 25, is substantially orthogonal to the pressing surface 31a. In the case of the embodiment, the pressing portion 31 has a substantially right triangular cross section so as to fill a region between the inner peripheral surface 31b side and the lower surface side of the pressing portion 31 (see FIGS. 2 to 4 and 9). In substantially the entire area, in the vertical direction, of the inner peripheral surface 31b side of the pressing portion 31, the internal thread 32 that can be screwed to the external thread 27 formed in the main body 26 is formed over the entire circumference (see FIG. 9). The pressing portion 31 has an outer diameter dimension set to be larger than the outer diameter dimension of the flange portion 28 of the inflator 25. Specifically, the outer diameter dimension of the pressing portion 31 is set such that the projected pieces 34 formed to extend downward from an outer peripheral edge 31c are positioned outside the flange portion 28 as described later (see FIGS. 3 and 4). In detail, a width dimension W1 of the pressing portion 31 is set to about 3/2 a width dimension W2 of the flange portion 28 (see FIG. 4).

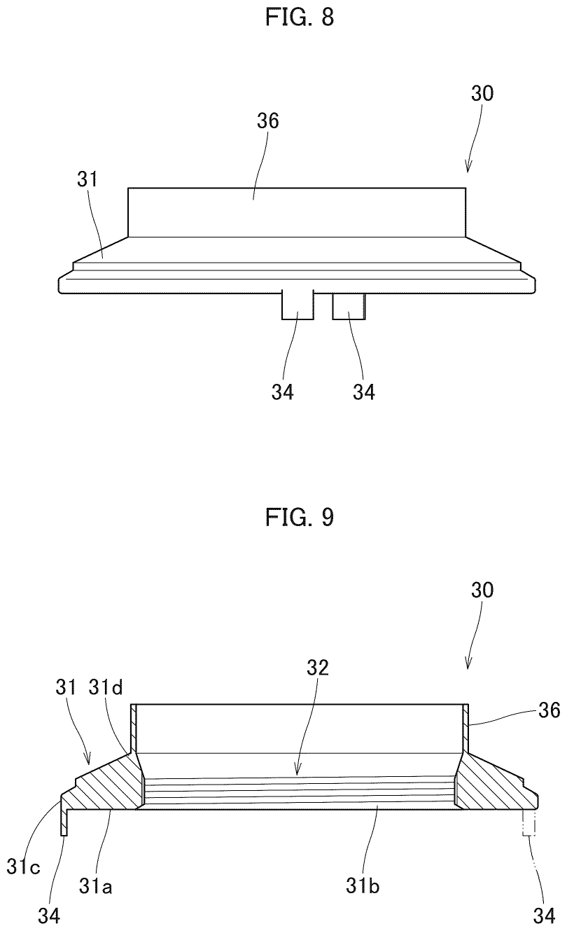

In the case of the embodiment, the projected pieces 34 serving as the projections are formed to extend from the outer peripheral edge 31c of the pressing portion 31 downward toward the bottom wall portion 13 (bag holder) side of the case 12. Specifically, the projected pieces 34 are formed at two places that are substantially point-symmetric with respect to the central axis (coinciding with the central axis of the main body 26 of the inflator 25) (see FIGS. 5 and 7 to 9). The projected pieces 34 are formed to extend substantially along the central axis. A projection amount (length dimension) of the projected pieces 34 from the pressing surface 31a is set to such a dimension that causes tips 34a (lower ends) to protrude downward beyond the lower surface 13c of the bottom wall portion 13 when the inflator 25 and the airbag 20 are attached to the case 12 with the retainer 30 (see FIG. 4). In the case of the embodiment, a width dimension of the projected pieces 34 is set to be substantially equal to the length dimension (see FIG. 8).

The side wall portion 36 is formed so as to substantially continue from the inner peripheral surface 31b of the pressing portion 31 and to extend upward (along the axial direction of the main body 26) from an upper end 31d side of the pressing portion 31 (see FIG. 9). As illustrated in FIG. 4, the side wall portion 36 has such a substantially circular cylinder shape that a gap is provided between the side wall portion 36 and the outer peripheral surface 26b of the main body 26. Furthermore, an upper end 36a of the side wall portion 36 is positioned slightly lower than an upper surface 26c of the main body 26. That is, the side wall portion 36 is configured to cover substantially the entire outer peripheral surface 26b side (in detail, the outer peripheral surface side of the region, of the main body 26, on the upper side of the external thread 27) of the main body 26. In still other words, the side wall portion 36 is configured to cover the outer side, in the direction orthogonal to the axis, of the substantially entire of the region in the main body 26 where the gas discharge ports 26a are disposed.

Next, it will be described how the airbag device M according to the embodiment is mounted on a vehicle. The retainer 30 is disposed on the inner peripheral surface side of the peripheral edge of the inflow opening 20a of the airbag 20 such that the projected pieces 34 protrude through the through-holes 20b. The airbag 20, in which the retainer 30 is disposed, is then folded so as to be storable in the case 12. Next, the periphery of the folded airbag 20 is wrapped with a wrapping material capable of keeping the folded shape while the projected pieces 34 of the retainer are kept projecting from the through-holes 20b. Thereafter, the folded airbag 20 (folding completion body) is housed in the case 12 so as to be placed on the bottom wall portion 13 while inserting the projected pieces 34 through the locking holes 13b. Next, while inserting the main body 26 of the inflator 25 into the insertion hole 13a formed in the bottom wall portion 13, the inflator 25 itself is rotated with respect to the retainer 30 and the case 12, so that the external thread 27 formed on the outer peripheral surface 26b of the main body 26 is screwed (fastened) to the internal thread 32 formed in the inner peripheral surface 31b of the pressing portion 31 of the retainer 30. As a result, the folded airbag 20 and the inflator 25 can be attached to the case 12. At this time, the airbag 20 is attached to the case 12 in the following manner. The peripheral edge of the inflow opening 20a is positioned by the projected pieces 34 with respect to the case 12 and the retainer 30, and the peripheral edge of the inflow opening 20a is sandwiched, together with the portion of the peripheral edge of the insertion hole 13a in the bottom wall portion 13 of the case 12, by the pressing portion 31 of the retainer 30 and the flange portion 28 of the inflator 25. Then, when the airbag cover 7 is attached to the case 12, the airbag device M can be assembled.

Thereafter, when the airbag device M is fixed to the body side of the vehicle using a bracket (not illustrated) attached to the case 12, and a lead wire (not illustrated) is connected to the main body 26 of the inflator 25, the airbag device M can be mounted on the vehicle.

After the airbag device M is mounted on the vehicle, if the inflator 25 is activated at the time of occurrence of a frontal collision of the vehicle, and inflation gas is discharged from the gas discharge ports 26a, the airbag 20 is inflated by the inflation gas flowing into the inside of the airbag 20. Then, the airbag 20 pushes and opens the door portions 8a and 8a of the airbag cover 7 and completes the inflation while largely projecting rearward.

In the airbag device M of the embodiment, when the main body 26 of the inflator 25 is inserted into the retainer 30, and the internal thread 32 and the external thread 27 are screwed to each other, the inflator 25 can be connected to the retainer 30. Simultaneously at this time, the portion of the peripheral edge of the insertion hole 13a in the case 12, which serves as the bag holder, is sandwiched together with the portion of the peripheral edge of the inflow opening 20a in the airbag 20 by the pressing portion 31 of the retainer 30 and the flange portion 28 of the inflator 25, so that the airbag 20 and the inflator 25 can be held by the case 12. At this time, in the airbag device M of the embodiment, the projected pieces 34 extending, as the projections, from the pressing portion 31 of the retainer 30 penetrate through the airbag 20 and the bottom wall portion 13 of the case 12. That is, with such projected pieces 34 disposed to penetrate through the airbag 20 and the bottom wall portion 13 of the case 12, the peripheral edge portion of the inflow opening 20a of the airbag 20 can be easily positioned with respect to the case 12 (bottom wall portion 13) and the retainer 30, and the peripheral edge of the inflow opening 20a of the airbag 20 can therefore be stably pressed by the pressing portion 31 of the retainer 30 and the case 12 (bottom wall portion 13) while suppressing an occurrence of displacement.

Therefore, in the airbag device M of the embodiment, the airbag 20 and the inflator 25 can be easily attached to the case 12 serving as the bag holder by using the retainer 30.

In addition, in the airbag device M according to the embodiment, the airbag 20 and the inflator 25 can be attached to the case 12 using the retainer 30 only by screwing (fastening) the external thread 27 to the internal thread 32. In other words, when the fastening state between the internal thread 32 and the external thread 27 is released, the connection state between the inflator 25 and the retainer 30 can be released, and the inflator 25 and the airbag 20 can be removed from the case 12. Therefore, at the time of scrapping the vehicle or other occasions, a removal work of the airbag device from the vehicle body side can be easily performed. In detail, when the main body 26 is rotated in the direction opposite to the fastening direction with respect to the case 12 after the lead wire (not illustrated) is removed from the main body 26, the fastening state of the internal thread 32 and the external thread 27 can be released, and the inflator 25 can be removed from the case 12. That is, in the airbag device M of the embodiment, even when the state of the inflator 25 cannot be visually observed, the inflator 25 can be detached from the case 12 only by rotating the main body 26 with respect to the case 12. Therefore, in the case where the present invention is applied to the airbag device M for a passenger seat as in the embodiment, the inflator 25 can be removed from the case 12 without removing the instrument panel 1 in the following manner. At the time of scrapping the vehicle, a glove box 4 (see FIG. 1) provided, for example, in a lower region in front of the passenger seat (a lower region behind the airbag device) is removed, and a hand is inserted through a gap thereby formed. As a result, as compared with a case where a retainer provided with four bolts is used as in the conventional manner, the removal work of the inflator 25 is remarkably easy, and the operation time can be significantly reduced.

In addition, in the airbag device M according to the embodiment, the retainer 30 includes the side wall portion 36 that covers the outer side, in the direction orthogonal to the axis, of the region in the main body 26 of the inflator 25 where the gas discharge ports 26a are disposed. Therefore, it is possible to deflect the inflation gas discharged, from the gas discharge ports 26a, toward the direction orthogonal to the axial direction of the main body 26 such that the discharged gas is directed along the axis direction of the main body 26 along the side wall portion 36 provided on the retainer 30. That is, by providing the side wall portion 36, it is possible to deflect the inflation gas radially discharged from the gas discharge ports 26a toward the upper end of the case 12 and to thereby cause the discharged gas to quickly flow into the airbag 20. Of course, in a case where such a point is not taken into consideration, a retainer configured to include no side wall portion may be used as the retainer.

Furthermore, in the airbag device M of the embodiment, the projected pieces 34 serving as the projections are formed to extend from the outer peripheral edge 31c of the pressing portion 31 toward the bottom wall portion 13 of the case 12. In the embodiment, the retainer 30 is formed by forging. However, when the retainer is configured such that projections (projected pieces) are projected from intermediate portions between the inner side and the outer side of the pressing portion, the retainer needs to be formed by cutting or the like. As in the embodiment, when the projected pieces 34 are provided on the outer peripheral edge 31c side of the pressing portion 31, the retainer can be manufactured by forging or pressing, which is relatively easy, so that the number of manufacturing steps and cost can be reduced as compared with the case of manufacturing the retainer by cutting. Note that the pressing portion 31 of the retainer 30 of the embodiment has a substantially right triangular cross section so as to fill the region between the inner peripheral surface 31b side and the lower surface side, but the shape of the retainer is not limited by the embodiment. As long as the pressing portion is configured so as to secure enough strength to adequately press the peripheral edge of the inflow opening of the airbag when the airbag is unfolded and inflated, the pressing portion may have, for example, an L-shaped cross section. When the pressing portion is made to have an L-shaped cross section, the retainer can be manufactured by pressing.

In the retainer 30 of the airbag device M according to the embodiment, the projected pieces 34 (projections) are provided at two places that are substantially point-symmetric, but the number of the disposed projections is not limited by the embodiment. The projection of the retainer (the corresponding through-hole of the airbag and locking hole of the case) may be provided at one place or at three or more places.

The embodiment has described an airbag device for a passenger seat as an embodiment of the airbag device, but the present disclosure is not limited to the airbag device for a passenger seat. The present disclosure is applicable to an airbag device using a so-called disc-type inflator including a main body having a columnar shape, and is also applicable to, for example, an airbag device for a steering wheel.

The present disclosure relates to an airbag device having the following configuration.

An airbag device of the present disclosure includes:
an airbag;
an inflator, the inflator including
   a main body having a substantially columnar shape, and
   a flange portion projecting from the main body, the inflator supplying inflation gas to the airbag;
a bag holder having an insertion hole that allows the main body to be inserted through the bag holder, the bag holder holding the airbag and the inflator; and
a retainer with which the airbag and the inflator are held by the bag holder,
wherein
the retainer has a substantially annular shape that allows the main body to be inserted through the retainer,
the retainer has a pressing portion that is configured to press, from an inner peripheral side, a peripheral edge of an inflow opening that is provided in the airbag so as to allow the main body to be inserted,
the retainer includes an internal thread on an inner peripheral surface side of the pressing portion, and
the inflator includes an external thread on an outer peripheral surface side near the flange portion of the main body, the external thread configured to be screwed to the internal thread, and
wherein
the retainer is configured to cause the bag holder to hold the airbag and the inflator by causing, when the external thread and the internal thread are screwed to each other, the pressing portion and the flange portion to sandwich a portion of a peripheral edge of the insertion hole in the bag holder, and
the retainer includes a projection that projects from the pressing portion so as to penetrate through the airbag and the bag holder.

In the airbag device of the present disclosure, the inflator can be connected to the retainer by inserting the main body of the inflator into the retainer and screwing the internal thread and the external thread to each other. Simultaneously at this time, the portion of the peripheral edge of the insertion hole in the bag holder is sandwiched together with the portion of the peripheral edge of the inflow opening in the airbag by the pressing portion of the retainer and the flange portion of the inflator, so that the airbag and the inflator can be held by the bag holder. At this time, in the airbag device of the present disclosure, the projections extending from the pressing portion of the retainer penetrate through the airbag and the bag holder. That is, by disposing such projections so as to penetrate through the airbag and the bag holder, the peripheral edge portion of the inflow opening of the airbag can be easily positioned with respect to the bag holder and the retainer, and the peripheral edge of the inflow opening of the airbag can be stably pressed by the pressing portion of the retainer and the bag holder while suppressing an occurrence of displacement.

Therefore, in the airbag device of the present disclosure, the airbag and the inflator can be easily attached to the bag holder using the retainer.

Furthermore, in the airbag device of the present disclosure, only by screwing (fastening) the external thread to the internal thread, the airbag and the inflator can be attached to the bag holder using the retainer. In other words, when the fastening state between the internal thread and the external thread is released, the connection state between the inflator and the retainer can be released, and the inflator and the airbag can be removed from the bag holder. Therefore, at the time of scrapping the vehicle or other occasions, a removal work of the airbag device from the vehicle body side can be easily performed.

Furthermore, in the airbag device of the present disclosure, the following configuration is preferable. Gas discharge ports capable of discharging inflation gas are provided on the side of the outer peripheral surface, in the direction around the axis, in the main body of the inflator, and

a side wall portion is provided on the retainer so as to extend substantially along the axial direction of the main body to cover the outer side, in the direction orthogonal to the axis, of the region in the main body where the gas discharge ports are disposed.

With such a configuration of the airbag device, it is possible to deflect the inflation gas discharged, from the gas discharge ports in the main body of the inflator, toward the direction orthogonal to the axial direction of the main body such that the discharged gas is directed along the axial direction of the main body by the side wall portion provided on the retainer, so that the discharged gas is caused to quickly flow into the airbag

Furthermore, in the airbag device configured as described above, the projections are preferably formed so as to extend from the outer peripheral edge of the pressing portion toward the bag holder. With the above configuration, the retainer can be easily formed as compared with the case where the projections are formed to project from the intermediate portions between the inner side and the outer side of the pressing portion.

What is claimed is:

1. An airbag device comprising:
an airbag;
an inflator, the inflator including
a main body having a substantially columnar shape, and
a flange portion projecting from the main body, the inflator supplying inflation gas to the airbag;
a bag holder having an insertion hole that allows the main body to be inserted through the bag holder, the bag holder holding the airbag and the inflator; and
a retainer with which the airbag and the inflator are held by the bag holder,
wherein
the retainer has a substantially annular shape that allows the main body to be inserted through the retainer,
the retainer has a pressing portion that is configured to press, from an inner peripheral side, a peripheral edge of an inflow opening that is provided in the airbag so as to allow the main body to be inserted,
the retainer includes an internal thread on an inner peripheral surface side of the pressing portion, and
the inflator includes an external thread on an outer peripheral surface side near the flange portion of the main body, the external thread configured to be screwed to the internal thread, and
wherein
the retainer is configured to cause the bag holder to hold the airbag and the inflator by causing, when the external thread and the internal thread are screwed to each other, the pressing portion and the flange portion to sandwich a portion of a peripheral edge of the insertion hole in the bag holder, and
the retainer includes a projection that projects from the pressing portion so as to penetrate through the airbag and the bag holder.

2. The airbag device according to claim 1, wherein the inflator includes a gas discharge port provided on a side of an outer peripheral surface, in a direction around an axis of the main body, in the main body, the gas discharge port configured to discharge inflation gas, and
the retainer includes a side wall portion that extends along a direction of the axis of the main body and covers an outer side, in a direction orthogonal to the axis, of a region of the main body where the gas discharge port is disposed.

3. The airbag device according to claim 1, wherein the projection is formed so as to extend from an outer peripheral edge of the pressing portion toward the bag holder.

4. The airbag device according to claim 1, wherein the pressing portion has a substantially right triangular cross section so as to fill a region between the inner peripheral surface side and a lower surface side of the pressing portion.
